(19) United States
(12) Patent Application Publication
(10) Pub. No.: US 2022/0256579 A1
(43) Pub. Date: Aug. 11, 2022

(54) METHOD AND APPARATUS FOR RESERVING SIDELINK RESOURCES

(71) Applicant: FUJITSU LIMITED, Kawasaki-shi (JP)

(72) Inventors: Pengyu JI, Beijing (CN); Jian ZHANG, Beijing (CN); Lei ZHANG, Beijing (CN); Xin WANG, Beijing (CN)

(73) Assignee: FUJITSU LIMITED, Kawasaki-shi (JP)

(21) Appl. No.: 17/729,199

(22) Filed: Apr. 26, 2022

Related U.S. Application Data
(63) Continuation of application No. PCT/CN2019/116303, filed on Nov. 7, 2019.

(51) Int. Cl. H04W 72/12; H04L 5/00; H04W 72/04

(52) U.S. Cl. CPC H04W 72/1284; H04W 72/0406; H04L 5/0055

(57) ABSTRACT

A method and apparatus for reserving sidelink resources. The method includes: receiving by a first terminal equipment first indication information indicating a second time-frequency resource transmitted by a second terminal equipment, wherein the second time-frequency resource at least partially overlaps a reserved or allocated first time-frequency resource of the first terminal equipment; and transmitting by the first terminal equipment to a network device second indication information indicating that the first time-frequency resource is at least partially pre-empted.

### CROSS-REFERENCE TO RELATED APPLICATION

This application is a continuation application of International Application PCT/CN2019/116303 filed on Nov. 7, 2019 and designated the U.S., the entire contents of which are incorporated herein by reference.

### TECHNICAL FIELD

This disclosure relates to the field of communication technologies.

### BACKGROUND

In Rel-15 and vehicle-to-everything (V2X) communication of previous versions, two modes of sidelink resources allocation are supported: Mode 1 and Mode 2. For Mode 1, sidelink resources are obtained through allocation by a network device (e.g. a base station); and for Mode 2, a terminal equipment autonomously selects transmission resources, that is, the transmission resources are obtained in a sensing or detection-resource selection process.

For example, a user equipment (UE) continuously senses to obtain resource occupancy in an entire resource pool, and some resources reserved by other UEs may be excluded in a process of detecting resources in a sensing window, such as detecting sidelink control information (SCI) of other UEs and/or detecting reference signal received power (RSRP). In remaining “available” resources, some candidate resources with better received signal strength indicators (RSSIs) are selected to form a set, and one resource is randomly selected therefrom for data transmission of Mode 2.

On the other hand, in Rel-15, for a Uu interface, i.e. a communication interface between a network device (such as a base station) and a terminal equipment (such as a UE), a resource pre-emption mechanism is supported.

For example, the network device may schedule a terminal equipment transmitting URLLC services to pre-empt resources that have been allocated to a terminal equipment transmitting eMBB services, so as to meet requirements of URLLC services for low latency and high reliability. In addition, by transmitting DCI (format 2-1) carried by a group common physical downlink control channel (PDCCH), the network device may notify the terminal equipment transmitting eMBB services of resources that are pre-empted by the terminal equipment transmitting URLLC services, so as to eliminate influence of the pre-empted resources on demodulation of the terminal equipment transmitting eMBB services.

It should be noted that the above description of the background art is merely provided for clear and complete explanation of this disclosure and for easy understanding by those skilled in the art. And it should not be understood that the above technical solution is known to those skilled in the art as it is described in the background art of this disclosure.

### SUMMARY

However, it was found by the inventors that a spectral efficiency of resources in a sidelink is relatively important, and in some cases, channel occupation may be congested in a resource pool. In the sidelink communication, especially the sidelink communication based on the new generation air interface technology, it may be necessary to support some services similar to URLLC on a Uu interface, that is, the services have relatively high requirements on latency and reliability. In this case, how to meet demands of this type of services in such a situation needs to be taken into account.

In New Radio (NR) V2X, if a mechanism similar to the resource pre-emption in the Uu interface is not supported on a sidelink, that is, the resource selection mechanism of LTE V2X is not enhanced, it may possibly result in that some services with relatively high priorities are unable to obtain appropriate resources in a process of resource selection, and requirements on delay and reliability may possibly not be met. Such a situation becomes especially obvious when loads in a resource pool are relatively heavy, which seriously affects transmission of services with higher priorities.

In order to solve at least one of the above problems, embodiments of this disclosure provide a method and apparatus for reserving sidelink resources.

According to an aspect of the embodiments of this disclosure, there is provided an apparatus for reserving sidelink resources, including:

a receiving unit configured to receive first indication information indicating a second time-frequency resource transmitted by a second terminal equipment, wherein the second time-frequency resource at least partially overlaps a reserved or allocated first time-frequency resource of the first terminal equipment; and

a transmitting unit configured to transmit to a network device second indication information indicating that the first time-frequency resource is at least partially pre-empted.

According to another aspect of the embodiments of this disclosure, there is provided a method for reserving sidelink resources, including:

receiving, by a first terminal equipment, first indication information indicating a second time-frequency resource transmitted by a second terminal equipment, wherein the second time-frequency resource at least partially overlaps a reserved or allocated first time-frequency resource of the first terminal equipment; and

transmitting, by the first terminal equipment to a network device, second indication information indicating that the first time-frequency resource is at least partially pre-empted.

According to a further aspect of the embodiments of this disclosure, there is provided an apparatus for reserving sidelink resources, including:

a receiving unit configured to receive first indication information indicating a second time-frequency resource transmitted by a second terminal equipment, wherein the second time-frequency resource at least partially overlaps a reserved or allocated first time-frequency resource of the first terminal equipment; and

a transmitting unit configured to transmit sidelink control information and/or sidelink data to a third terminal equipment by using remaining resources in the first time-frequency resource not overlapping with the second time-frequency resource.

According to still another aspect of the embodiments of this disclosure, there is provided a method for reserving sidelink resources, including:

receiving, by a first terminal equipment, first indication information indicating a second time-frequency resource transmitted by a second terminal equipment, wherein the second time-frequency resource at least partially overlaps a reserved or allocated first time-frequency resource of the first terminal equipment; and

transmitting sidelink control information and/or sidelink data by the first terminal equipment to a third terminal equipment by using remaining resources in the first time-frequency resource not overlapping with the second time-frequency resource.

According to yet another aspect of the embodiments of this disclosure, there is provided an apparatus for reserving sidelink resources, including:

a receiving unit configured to receive first indication information indicating a second time-frequency resource transmitted by a second terminal equipment, wherein the second time-frequency resource at least partially overlaps a reserved or allocated first time-frequency resource of the first terminal equipment;

a determining unit configured to determine whether a period of time between a first time at which reception of the first indication information is completed and a second time at which the first time-frequency resource is used by the first terminal equipment to transmit sidelink data is less than a threshold; and

a transmitting unit configured to, when the period of time is less than the threshold, transmit third indication information indicating clearing buffer data to a third terminal equipment receiving the sidelink data.

According to a yet further aspect of the embodiments of this disclosure, there is provided a method for reserving sidelink resources, including:

receiving, by a first terminal equipment, first indication information indicating a second time-frequency resource transmitted by a second terminal equipment, wherein the second time-frequency resource at least partially overlaps a reserved or allocated first time-frequency resource of the first terminal equipment;

determining by the first terminal equipment whether a period of time between a first time at which reception of the first indication information is completed and a second time at which the first time-frequency resource is used by the first terminal equipment to transmit sidelink data is less than a threshold; and

when the period of time is less than the threshold, transmitting third indication information indicating clearing buffer data by the first terminal equipment to a third terminal equipment receiving the sidelink data.

An advantage of the embodiments of this disclosure exists in that a mechanism of pre-emption of resources on a sidelink when a terminal equipment operates in Mode 1 or Mode 2 is supported, which may not only satisfy requirements of high-priority services on latency and reliability, but also influences on various situations are taken into account.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiments.

FIG. 1 is schematic diagram of a communication system of an embodiment of this disclosure;

FIG. 2 is a schematic diagram of selecting sidelink resources by a terminal equipment;

FIG. 3 is an exemplary diagram of resource pre-emption on a sidelink;

FIG. 4 is a schematic diagram of the method for reserving sidelink resources of an embodiment of this disclosure;

FIG. 5 is an exemplary diagram of reserving sidelink resources of the embodiment of this disclosure;

FIG. 6 is another schematic diagram of the method for reserving sidelink resources of the embodiment of this disclosure;

FIG. 7 is another exemplary diagram of reserving sidelink resource of the embodiment of this disclosure;

FIG. 8 is a further exemplary diagram of reserving sidelink resource of the embodiment of this disclosure;

FIG. 9 is a further schematic diagram of the method for reserving sidelink resources of the embodiment of this disclosure;

FIG. 10 is still another exemplary diagram of reserving sidelink resource of the embodiment of this disclosure;

FIG. 11 is still another schematic diagram of the method for reserving sidelink resources of the embodiment of this disclosure;

FIG. 12 is yet still another exemplary diagram of reserving sidelink resource of the embodiment of this disclosure;

FIG. 13 is yet still another schematic diagram of the method for reserving sidelink resources of the embodiment of this disclosure;

FIG. 14 is a schematic diagram of the apparatus for reserving sidelink resources of an embodiment of this disclosure;

FIG. 15 is a schematic diagram of the network device of an embodiment of this disclosure; and

FIG. 16 is a schematic diagram of the terminal equipment of an embodiment of this disclosure.

### DETAILED DESCRIPTION

These and further aspects and features of this disclosure will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to an equipment in a communication system that accesses a terminal equipment to the communication network and provides services for the terminal equipment. The network device may include but not limited to the following equipment: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, which may be expressed as a serving cell, and may be a macro cell or a pico cell, depending on a context of the term.

In the embodiments of this disclosure, the term “user equipment (UE)” or “terminal equipment (TE) or terminal device” refers to, for example, equipment accessing to a communication network and receiving network services via a network device. The terminal equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Moreover, the term “network side” or “network device side” refers to a side of a network, which may be a base station, and may include one or more network devices described above. The term “user side” or “terminal side” or “terminal equipment side” refers to a side of a user or a terminal, which may be a UE, and may include one or more terminal equipments described above.

Scenarios in the embodiments of this disclosure shall be described below by way of examples; however, this disclosure is not limited thereto.

FIG. 1 is a schematic diagram of a communication system of an embodiment of this disclosure, in which a case where terminal equipments and a network device are taken as examples is schematically shown. As shown in FIG. 1, the communication system 100 may include a network device 101 and terminal equipments 102, 103. For the sake of simplicity, an example having only two terminal equipments and one network device is schematically given in FIG. 1; however, the embodiment of this disclosure is not limited thereto.

In the embodiment of this disclosure, existing services or services that may be implemented in the future may be performed between the network device 101 and the terminal equipments 102, 103. For example, such services may include but not limited to an enhanced mobile broadband (eMBB), massive machine type communication (MTC), and ultra-reliable and low-latency communication (URLLC), etc.

It should be noted that FIG. 1 shows that two terminal equipments 102, 103 are both within a coverage of the network device 101. However, this disclosure is not limited thereto, and the two terminal equipments 102, 103 may not be within the coverage of the network device 101, or one terminal equipment 102 is within the coverage of the network device 101 and the other terminal equipment 103 is outside the coverage of the network device 101.

In the embodiments of this disclosure, sidelink transmission may be performed between two terminal equipments 102, 103. For example, the two terminal equipments 102, 103 may both perform sidelink transmission within the coverage of the network device 101 to implement V2X communications, or both of them may perform sidelink transmission outside the coverage of the network device 101 to implement V2X communications, and it may also be that one terminal equipment 102 is within the coverage of the network device 101 and another terminal equipment 103 is outside the coverage of the network device 101 and perform sidelink transmission to implement V2X communications.

During the discussion at the Rel-16 NR V2X meeting, RANI agreed that Mode 1 (resources are scheduled by a network device) and Mode 2 (resources are autonomously selected by a terminal equipment) also needs to be supported in NR V2X; and for unicast and groupcast, feedback on a sidelink is supported, and a transmitting terminal equipment operating in Mode 1 may report a feedback result to the network device. Hereinafter, the terminal equipment operating in Mode 1 mode is referred to as a Mode 1 UE for short, and a terminal equipment working in Mode 2 is referred to as a Mode 2 UE for short.

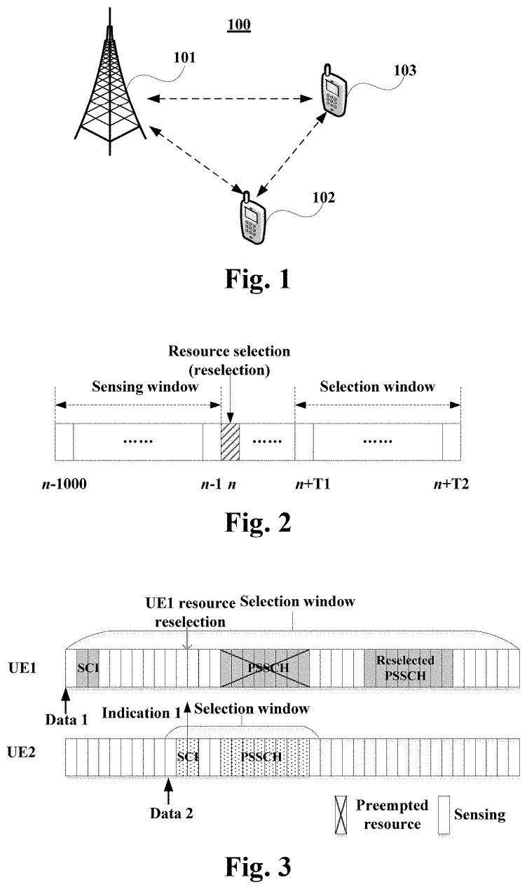

FIG. 2 is a schematic diagram of selecting sidelink resources by a terminal equipment. As shown in FIG. 2, the terminal equipment may sense or detect multiple time-frequency resources by using a sensing window, and may select appropriate sidelink resources by using a selection window.

On the sidelink, the terminal equipment may transmit each transmission block (TB) multiple times to improve reliability of demodulation, and may support two retransmission modes: retransmission based on hybrid automatic repeat request (HARD) feedback, or blind retransmission. For a Mode 1 UE, retransmission resources and initial transmission resources are together allocated by the network device; and for a Mode 2 UE, retransmission resources are obtained together with initial transmission resources by a transmitting terminal equipment in a resource selection process, that is, the transmitting terminal equipment selects multiple resources, which are respectively used for initial transmission and one or more times of possible retransmission.

In order to meet a requirement of a high-priority service for performance, introduction of a resource pre-emption mechanism on a sidelink may be a possible method. That is, pre-empting resources reserved by a transmitting terminal equipment of a low-priority service by a transmitting terminal equipment of a high-priority service is supported, which may preferentially satisfy demands of high-priority services.

FIG. 3 is an exemplary diagram of resource pre-emption on a sidelink. As shown in FIG. 3, for example, if UE 1 reserves resources for service transmission, reserved resources and service priorities may be indicated via reservation indication information (not shown in FIG. 3). The reservation indication information may be carried by a standalone physical sidelink control channel (PSCCH), a PSCCH to which a physical sidelink shared channel (PSSCH) transmitted last time corresponds, or a PSCCH to which a PSSCH transmitted in a last period corresponds, or may be carried by sub-channel transmission.

As shown in FIG. 3, if a priority of data to be transmitted of UE 2 (Data 2) is higher than a priority of data of UE 1 (Data 1), UE 2 may pre-empt reserved resources of UE 1, and at the same time, transmit reservation indication information (indication 1 shown in FIG. 3) to notify UE 1, and UE 1 may trigger a resource reselection process to select other resources for data transmission.

FIG. 3 exemplarily shows a scenario of resource pre-emption between two Mode 2 UEs. However, as the resources of Mode 1 UE and Mode 2 UE may coexist in the same resource pool, situations of pre-empting resources and resources being pre-empted are not limited to a scenario of being performed between Mode 2 UEs.

For example, when a pre-empted UE operates in Mode 1, sidelink resources should be allocated by the network device, and a possible solution that the pre-empted UE is a Mode 1 UE needs to be taken into account. In addition, as resources of Mode 1 UE and Mode 2 UE may coexist in a resource pool, if Mode 2 UE needs to pre-empt the sidelink resources of Mode 1 UE, it cannot be scheduled or coordinated by the network device. Furthermore, an impact on existing resource selection and reservation mechanisms needs to be taken into account in the resource pre-emption mechanism on the sidelink, and avoidance of unnecessary data merging errors needs also to be taken into account.

The following embodiments of this disclosure propose corresponding solutions for one or more of the above problems, and provide more technical details and supplementary solutions for the resource pre-emption mechanism on a sidelink, making this mechanism more complete.

In the embodiments of this disclosure, the sidelink is described by taking V2X as an example; however, this disclosure is not limited thereto, and it may also be applicable to sidelink transmission scenarios other than V2X. In addition, sidelink control information (SCI) is carried by a PSCCH, sidelink data are carried by a PSSCH, and sidelink feedback information is carried by a physical sidelink feedback channel (PSFCH).

In the following description, terms “sidelink” and “V2X” are interchangeable, terms “PSFCH” and “sidelink feedback channel” are interchangeable, terms “PSCCH” and “sidelink control channel” or “sidelink control information” are interchangeable, and terms “PSSCH” and “sidelink data channel” or “sidelink data” are interchangeable.

In addition, transmitting or receiving a PSSCH may be understood as transmitting or receiving sidelink data carried by the PSSCH, and transmitting or receiving a PSFCH may be understood as transmitting or receiving sidelink feedback information carried by the PSFCH. At least one time of transmission may be understood as at least one time of PSSCH/PSCCH transmission or at least one time of sidelink data/information transmission, and current transmission may be understood as current PSSCH/PSCCH transmission or current sidelink data/information transmission.

### Embodiments of a First Aspect

The embodiments of this disclosure provide a method for reserving sidelink resources, which shall be described from a terminal equipment. The first terminal equipment is taken as a transmitter of service data to transmit sidelink data to one or more third terminal equipments, and a second terminal equipment is taken as a transmitter of other service data, with priorities of transmitting service data being higher than priorities of transmitting service data by the first terminal equipment.

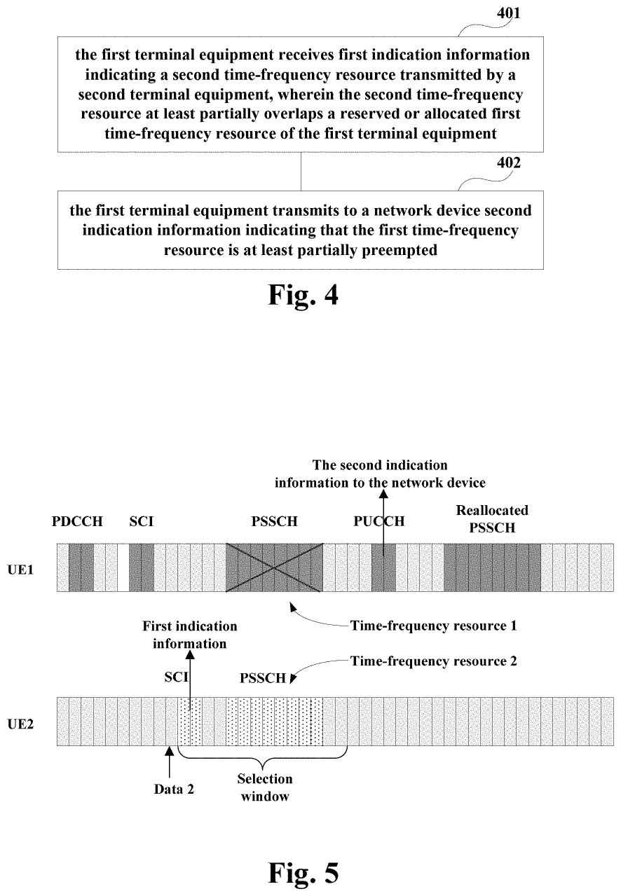

FIG. 4 is a schematic diagram of the method for reserving sidelink resources of the embodiment of this disclosure. As shown in FIG. 4, the method includes:

401: the first terminal equipment receives first indication information indicating a second time-frequency resource transmitted by a second terminal equipment, wherein the second time-frequency resource at least partially overlaps a reserved or allocated first time-frequency resource of the first terminal equipment; and

402: the first terminal equipment transmits to a network device second indication information indicating that the first time-frequency resource is at least partially pre-empted.

It should be noted that FIG. 4 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 4.

In this disclosure, the first time-frequency resource of the first terminal equipment is allocated by the network device, that is, the first terminal equipment operates in Mode 1. For example, the first terminal equipment is allocated the first time-frequency resource, which is used for transmission of sidelink data (e.g. eMBB services).

In this disclosure, a priority indicated by the first indication information is higher than a priority indicated by sidelink control information to which the first time-frequency resource corresponds. For example, the second terminal equipment is a Mode 2 UE, which indicates a resource to be used by its services (such as URLLC services) by transmitting the resource reservation information (as the first indication information) via SCI; and after receiving the resource reservation information, the first terminal equipment determines that the second time-frequency resource indicated by the resource reservation information at least partially overlaps with its own first time-frequency resource, and a priority corresponding to a PPPP (prose per packet priority) indicated by the SCI is higher than that indicated by the sidelink control information (such as corresponding to eMBB services) corresponding to the first time-frequency resource, then the first terminal equipment may determine that the first time-frequency resource is at least partially pre-empted.

The first time-frequency resource being implicitly pre-empted is described above by taking the resource reservation information in the SCI as an example. However, this disclosure is not limited thereto, and the first time-frequency resource may also be explicitly pre-empted. For example, the first indication information may include 1 bit with a value of “1”, indicating that the first indication information is a pre-emption indication. The first indication information explicitly indicates that the second time-frequency resource is to be used, so as to pre-empt a resource overlapping with the second time-frequency resource.

In some embodiments, after receiving the resource pre-emption indication information (first indication information) from the second terminal equipment, the first terminal equipment on the sidelink reports the second indication information to the network device to indicate that the previously allocated resources are pre-empted. And the second indication information may also be used to request the network device to reallocate additional sidelink resources for the first terminal equipment.

In some embodiments, the second indication information is carried in a scheduling request (SR) or a buffer status report (BSR) transmitted by the first terminal equipment to the network device.

For example, in a case when the first terminal equipment has no uplink resources (such as PUSCH resources) for a period of time (which may be determined by QoS or PPPP or delay requirement of a current sidelink), on a physical uplink control channel (PUCCH) used for the sidelink scheduling request after completing demodulation of the first indication information (for example, most recent; however, it is not limited thereto), a scheduling request (such as an SL SR) including or indicating the second indication information is transmitted.

For another example, in a case where the first terminal equipment has uplink resources (such as PUSCH resources) for a period of time, on an uplink resource after demodulation of the first indication information is completed (for example, most recent; however, it is not limited thereto), a buffer status report (such as an SL BSR) including or indicating the second indication information is transmitted. A content of the BSR may be identical to a content of a BSR transmitted last time for applying for the pre-empted resource.

In some embodiments, according to the first indication information, an MAC layer of the first terminal equipment may trigger transmission of the buffer status report, and/or, in a case of there is no uplink resource, the first terminal equipment may transmit a scheduling request. Thus, with the above embodiments, a new SR/BSR triggering mechanism may be achieved.

In some embodiments, under at least one of the following conditions, the first terminal equipment transmits the second indication information to the network device:

blind repeated transmission (blind retransmission) of a transport block is not configured in sidelink resource pool configuration information, feedback-based repeated transmission (feedback-based retransmission) is not configured in sidelink resource pool configuration information, the terminal equipment being able to report feedback information to the network device is not configured in a sidelink resource pool, an uplink resource reporting feedback information to the network device is not configured in a sidelink resource pool, or sidelink resource pool configuration information contains indication of resource pre-emption enabling.

In some embodiments, the second indication information is carried in a feedback message transmitted by the first terminal equipment to the network device. And when hybrid automatic repeat request feedback (HARQ) is enabled and an uplink resource reporting feedback information to the network device is configured, the first terminal equipment transmits the feedback message including or indicating the second indication information.

For example, after the first terminal equipment completes demodulating the first indication information, in the case where HARQ feedback of current transmission is enabled and an uplink resource (such as a PUCCH resource) reporting feedback information to the network device is configured, the first terminal equipment transmits feedback information with a content of “NACK” at timing and a PUCCH resource indicated in DCI to which the pre-empted resource allocation corresponds, and applies the network device for reallocation of resources.

In some embodiments, the first time-frequency resource is used for a first groupcast data of the sidelink, and the second indication information transmitted by the first terminal equipment to the network device is NACK.

The first groupcast (groupcast option 1) data are transmitted by the first terminal equipment to at least two third terminal equipments, and the at least two third terminal equipments are able to feed back NACK in the same physical sidelink feedback channel (PSFCH) in case of wrong decoding, and not to perform feedback in case of correct decoding. And reference may be made to related techniques for particular contents of the groupcast option 1.

For example, for groupcast transmission configured with groupcast option 1, the UE needs also to report “NACK”, indicating that a data packet is not received correctly and retransmission is applied. Different from unicast, if the transmitting terminal equipment of groupcast option 1 does not receive feedback on the sidelink, it is deemed that current decoding results of all receiving terminal equipments are “ACK”; if the transmitting terminal equipment does not report feedback information to the network device, the network device will deem that the first groupcast data are correctly transmitted and received.

In this disclosure, when the first time-frequency resource is pre-empted, the first terminal equipment feeds back “NACK” to the network device, thereby preventing the network device from erroneously deeming that the first groupcast data is transmitted and received correctly.

In some embodiments, the second indication information may be NACK, or may also be indication information different from ACK or NACK. For example, it may be a “pre-empted” indication, which may be indicated by a third sequence in a PUCCH in addition to indicating ACK and NACK; furthermore, each piece of feedback information may also be extended to 2 bits; for example, 00 is NACK, 01 ACK, and 10 is pre-empted indication, etc. After receiving the “pre-empted” indication, the network device may perform resource scheduling according to initial transmission, setting specific values of DCI indication fields, such as NDI, and RV, etc.

In some embodiments, the first terminal equipment transmits the second indication information under at least one of the following conditions:

blind repeated transmission of a transport block is not configured in sidelink resource pool configuration information, feedback-based repeated transmission is not configured in sidelink resource pool configuration information, or sidelink resource pool configuration information contains indication of resource pre-emption enabling. In some embodiments, when remaining resources other than the pre-empted time-frequency resources are unable to satisfy a transmission demand of the first terminal equipment for a current transport block, the first terminal equipment transmits the second indication information.

For example, situations of unsatisfying a transmission demand may include: maximum value configuration of a corresponding modulation and coding scheme (MCS) that may be selected by the current channel causes that a channel occupancy code rate does not meet a requirement, rate matching cannot be performed, and a channel occupancy code rate is too large, etc.; however, this disclosure is not limited thereto.

FIG. 5 is an exemplary diagram of reserving sidelink resources of the embodiment of this disclosure. As shown in FIG. 5, UE 1 is a Model UE, and is allocated with multiple sidelink resources (pre-allocated by the network device), including time-frequency resource 1 (e.g. a value of PPPP is 6). UE 2 is a Mode 2 UE, and after service data (data 2, for example, a value of PPPP is 2) arrive, UE 2 performs resource selection in a selection window to obtain multiple sidelink resources for transmitting data 2, including time-frequency resource 2. UE 2 will transmit SCI indicating the resource reservation information (first indication information), the SCI indicating time-frequency resource 2 and the value of 2 of the PPPP.

After UE 1 receives the SCI, it is determined that time-frequency resource 1 and time-frequency resource 2 at least partially overlap and a priority of the PPPP value 2 is higher than a priority of a PPPP value 6, and UE 1 deems that time-frequency resource 1 will be pre-empted by UE 2; and in a next PUCCH/PUSCH, UE 1 reports information (second indication information) on that time-frequency resource 1 is at least partially pre-empted to the network device.

In some embodiments, when the pre-empted services are resources in a configured grant (CG), the pre-empted terminal equipment may report assistance information to the network device after demodulating the pre-emption indication information; and the network device may reconfigure relevant parameters of the CG according to the assistance information to change configuration of the periodic services, such as a service period, and configuration of time-domain and frequency-domain resources, etc.

In this way, by reporting the indication information to the network device, Mode 1 UE may be enabled to re-obtain transmission resources when sidelink resources are pre-empted. The influence of the sidelink resource pre-emption mechanism on the terminal equipment of the pre-empted resources may be reduced, so that it may perform sidelink data transmission normally.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It can be seen from the above embodiments that a mechanism of pre-emption of resources on a sidelink when a terminal equipment operates in Mode 1 or Mode 2 is supported, which may not only satisfy requirements of high-priority services on latency and reliability, but also taking into account influences on various situations.

### Embodiments of a Second Aspect

The embodiments of this disclosure are described on the basis of the embodiments of the first aspect. The embodiments may be executed separately, or may be executed in combination with the embodiments of the first aspect, with contents identical to those in the embodiments of the first aspect being not going to be described herein any further.

The embodiments shall be described from a first terminal equipment. The first terminal equipment is taken as a transmitter of service data to transmit sidelink data to one or more third terminal equipments, and a second terminal equipment is taken as a transmitter of another service data, with priorities of transmitting service data being higher than priorities of transmitting service data by the first terminal equipment.

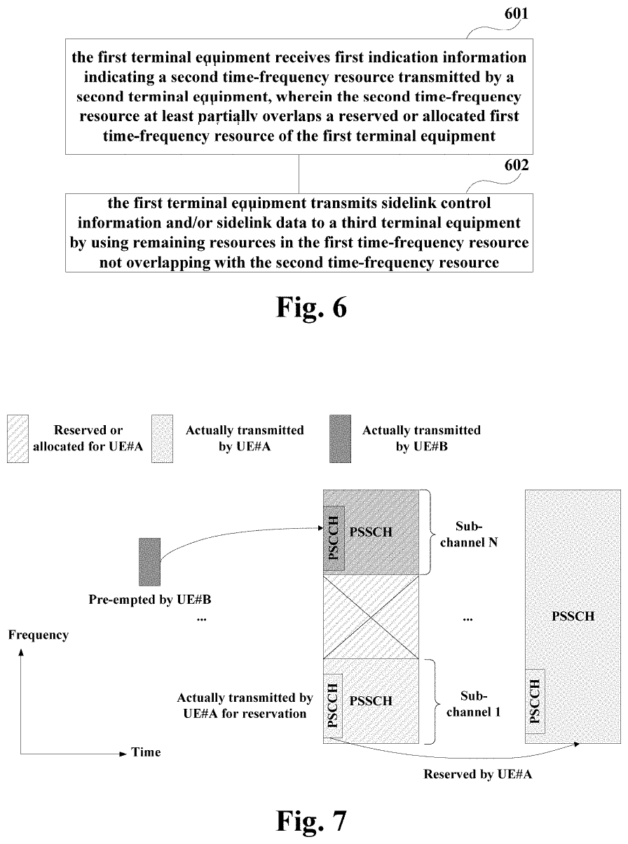

FIG. 6 is a schematic diagram of the method for reserving sidelink resources of the embodiment of this disclosure. As shown in FIG. 6, the method includes:

601: the first terminal equipment receives first indication information indicating a second time-frequency resource transmitted by a second terminal equipment, wherein the second time-frequency resource at least partially overlaps a reserved or allocated first time-frequency resource of the first terminal equipment; and

602: the first terminal equipment transmits sidelink control information and/or sidelink data to a third terminal equipment by using remaining resources in the first time-frequency resource not overlapping with the second time-frequency resource.

It should be noted that FIG. 6 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 6.

In the disclosure, the first time-frequency resource of the first terminal equipment may be allocated by the network device, that is, the first terminal equipment may operate in Mode 1. Alternatively, the first time-frequency resource of the first terminal equipment may be obtained by selecting sidelink resources, that is, the first terminal equipment may operate in Mode 2.

In some embodiments, the first terminal equipment transmits the sidelink data by using the remaining resources in a case that the remaining resources meet a requirement of current transmission.

For example, in a case where indication information on that reserved resources are pre-empted indicated by the other UE is detected and the indication information indicates that a part of reserved resources of a current UE is pre-empted, such as some sub-channels in all sub-channels of the reserved resources are occupied, if the remaining resources may be used to transmit the current data according to a QoS demand and/or PPPP and/or MCS demands of the data to be transmitted, the current UE performs rate matching on the current data, and then transmits the current data in resources remained after the pre-empted resources are removed from the reserved resources.

In some embodiments, when the current transmission is one time of transmission in multiple times of transmission, the first terminal equipment uses one sub-channel in the remaining resources to transmit sidelink control information indicating resources transmitted next one or more times. The current transmission is transmission in which multiple times of feedback-based retransmission or blind retransmission are configured for the same transport block and is not the last transmission, and/or the current transmission is transmission in a periodic service and does not trigger resource reselection.

In some embodiments, the remaining resources include one or more sub-channels, and the first terminal equipment uses one sub-channel (single sub-channel) in the remaining resources to transmit the sidelink control information and/or sidelink data to the third terminal equipment, wherein the sub-channel at least includes a physical sidelink control channel (PSCCH) resource.

For example, a frequency-domain index of the sub-channel in the remaining resources is lowest, or a frequency-domain index of the sub-channel in the remaining resources is highest, or the sub-channel is a configured or preconfigured resource in the remaining resources; however, this disclosure is not limited thereto.

In an example, if the current transmission is one time of transmission of multiple times of transmission, that is, retransmission based on HARQ feedback or multiple times of blind retransmission are configured for the same TB and is not the last time of transmission, and/or, the current transmission is one time of transmission in a periodic service and resource reselection is not triggered, the UE only performs one time of transmission of PSCCH and PSSCH in one sub-channel.

For example, a content transmitted in the PSSCH is a part of data in a TB to be transmitted, according to the MCS determined by the UE (such as being determined according to a configured/pre-configured range by existing network device, and/or, based on a CBR measurement range), these data are mapped onto the sub-channel.

For another example, the selected sub-channel may be a sub-channel with a lowest index in the remaining sub-channels after the reserved resources are removed from the pre-empted resources, or may be one of other sub-channels, which is illustrative only, and this disclosure is not limited thereto. And reserved resources transmitted next time and/or in a next period are indicated in the PSCCH. In this way, an entire reservation chain will not be destroyed due to the pre-empted resources.

In another example, if the current transmission is one time of transmission in multiple times of transmission, that is, multiple times of retransmission based on HARQ feedback or multiple times of blind retransmission are configured for the same TB and is not the last time of transmission, and/or, the current transmission is one time of transmission in a periodic service and resource reselection is not triggered, the UE only performs one time of transmission of PSSCH in one sub-channel.

For example, in the selected sub-channel, PSSCH data may not be transmitted, and only PSCCH information may be transmitted; in this case, the PSCCH is a standalone PSCCH, and reserved resources to be transmitted next time and/or in the next period are indicated therein. In this way, the entire reservation chain will not be destroyed due to pre-empted resources.

FIG. 7 is another exemplary diagram of reserving sidelink resource of the embodiment of this disclosure. As shown in FIG. 7, after resources reserved or allocated for UE #A are pre-empted by UE #B, remaining resources (shown by sub-channel 1 in FIG. 7) may be used to transmit SCI, indicating reserved resources to be transmitted next time and/or in the next period. In this way, the entire reservation chain will not be destroyed due to pre-empted resources.

In some embodiments, the sidelink control information of the last time of transmission in the multiple times of transmission further includes reservation information of one or more times of transmission. Resources of the one or more times of transmission may be obtained by performing sidelink resource selection based on a resource selection window.

For example, in a case when multiple times of retransmission based on HARQ-ACK feedback or multiple times of blind retransmission are configured for the same TB, if this time of transmission cannot be performed due to that resources of one or more times of transmission in the middle are pre-empted, one or more times of transmission resources may be additionally reserved in SCI transmitted in the last time, and the number of times may be equal to the number of times of being pre-empted, or may not be limited.

For these additional transmissions, a resource selection window to which they correspond may start from an ending symbol of a resource of a last time transmission reserved for the first time or from a first symbol of a next time slot or a slot after a predetermined number slots, until a last symbol of a slot after a packet delay budget(PDB) length of the data packet. However, this disclosure is not limited thereto, and a particular starting/ending positions and a size of the resource selection window may be adjusted based on practical situations.

Therefore, by transmitting the sidelink control information and/or the sidelink data by using the remaining resources (reservation remaining mechanism), Mode 1 UE or Mode 1 UE may be made to ensure completeness of the reservation chain when sidelink resources are pre-empted. The influence of the sidelink resource pre-emption mechanism on the terminal equipment of the pre-empted resources may be reduced, so that it may normally perform sidelink data transmission.

The above implementations only illustrate the embodiments of this disclosure. However, this disclosure is not limited thereto, and appropriate variants may be made on the basis of these implementations. For example, the above implementations may be executed separately, or one orthem may be executed in a combined manner.

It can be seen from the above embodiments that a mechanism of pre-emption of resources on a sidelink when a terminal equipment operates in Mode 1 or Mode 2 is supported, which may not only satisfy requirements of high-priority services on latency and reliability, but also taking into account influences on various situations.

### Embodiments of a Third Aspect

The embodiments of this disclosure are described on the basis of the embodiments of the first and second aspects. The embodiments may be executed separately, or may be executed in combination with the embodiments of the first and second aspects, with contents identical to those in the embodiments of the first and second aspects being not going to be described herein any further.

The embodiments are described from a second terminal equipment and a first terminal equipment. The first terminal equipment is taken as a transmitter of service data to transmit sidelink data to one or more third terminal equipments, and the second terminal equipment is taken as a transmitter of another service data, with priorities of transmitting service data being higher than priorities of transmitting service data by the first terminal equipment.

In this disclosure, a first time-frequency resource of the first terminal equipment may be allocated by the network device, that is, the first terminal equipment may operate in Mode 1. Alternatively, the first time-frequency resource of the first terminal equipment may also be obtained by selecting sidelink resources, that is, the first terminal equipment may operate in Mode 2.

In some embodiments, the second terminal equipment determines whether a period of time between a first time at which the first terminal equipment completes in reception of first indication information indicating a second time-frequency resource and a second time at which a first time-frequency resource is used by the first terminal equipment to transmit sidelink data is less than a threshold, wherein the reserved or allocated first time-frequency resource of the first terminal equipment at least partially overlaps the second time-frequency resource to be used by the second terminal equipment, and the second terminal equipment does not use the second time-frequency resource when the period of time is less than the threshold.

In some embodiments, the threshold is predefined or preconfigured or configured, and/or the threshold is determined according to a processing time of another terminal equipment capable of successfully processing the first indication information. And the threshold may be in units of slots or milliseconds.

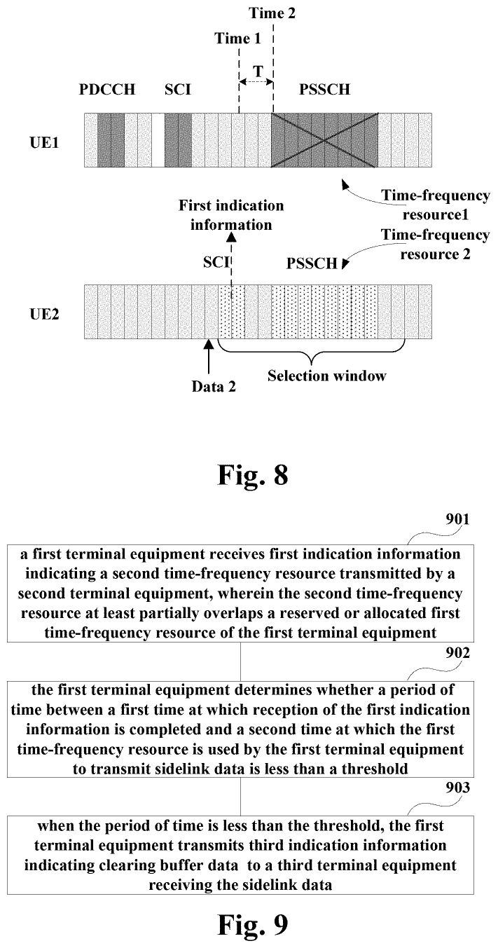

FIG. 8 is a further exemplary diagram of reserving sidelink resource of the embodiment of this disclosure. As shown in FIG. 8, UE 1 is a Model UE or a Mode 2 UE, and is reserved or allocated with multiple sidelink resources, including time-frequency resource 1 (e.g. a value of PPPP is 6). UE 2 is a Mode 2 UE, and after service data (data 2, for example, a value of PPPP is 2) arrive, UE 2 performs resource selection in the selection window to obtain multiple sidelink resources for transmitting data 2, including time-frequency resource 2. Time-frequency resource 1 and time-frequency resource 2 at least partially overlap and a priority of the PPPP value 2 is higher than a priority of the PPPP value 6.

UE 2 may learn situations of time-frequency resource 1 via a group common PDCCH transmitted by the network device or resource reservation information transmitted by UE 1. UE 2 will assume that SCI indicating the resource reservation information (the first indication information) is transmitted, the SCI will be received by UE 1 at time 1, and time-frequency resource 1 will be used by UE 1 at time 2, and there exists a period of time T between time 1 and time 2; assuming that UE 2 determines that UE 1 is unable to successfully demodulate and decode the SCI within this period of time T, UE 2 would not use time-frequency resource 2, that is, would not pre-empt time-frequency resource 1.

In this way, influence on the sidelink transmission of the first terminal equipment may be avoided.

In some embodiments, the second terminal equipment may pre-empt time-frequency resource 1 under the condition that the priority of the service data is relatively high, regardless of the influence on the first terminal equipment; and transmission power of the terminal equipment may be increased as the priority increases, that is, signals of high-priority services will overwhelm signals of low-priority services.

In this case, for the first terminal equipment, if the processing of the pre-emption message has not been completed, but the sidelink transmission on the originally reserved or allocated resources has already started, the transmitted service data of the sidelink transmission may be incorrect.

FIG. 9 is a further schematic diagram of the method for reserving sidelink resources of the embodiment of this disclosure. As shown in FIG. 9, the method includes:

901: a first terminal equipment receives first indication information indicating a second time-frequency resource transmitted by a second terminal equipment, wherein the second time-frequency resource at least partially overlaps a reserved or allocated first time-frequency resource of the first terminal equipment;

902: the first terminal equipment determines whether a period of time between a first time at which reception of the first indication information is completed and a second time at which the first time-frequency resource is used by the first terminal equipment to transmit sidelink data is less than a threshold; and

903: when the period of time is less than the threshold, the first terminal equipment transmits third indication information indicating clearing buffer data to a third terminal equipment receiving the sidelink data.

It should be noted that FIG. 9 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 9.

In some embodiments, in a case where the current transmission is one time of transmission of multiple times of transmission, the third indication information is carried in sidelink control information of a time of transmission after the current transmission, and indicates whether buffer data transmitted in one or more previous times are flushed.

For example, after demodulation of the pre-emption indication information (first indication information) is completed, buffer flush (third indication information) may be indicated in subsequent transmission or retransmission of the same TB to avoid erroneous retransmission merging. For example, a new field may be used in the SCI to indicate whether previous one or N times transmission need to be flushed, that is, indicating whether to flush buffer of a corresponding HARQ process; or, an existing field in the SCI may be reused to indicate whether previous one or N times transmission need to be flushed; however, this disclosure is not limited thereto.

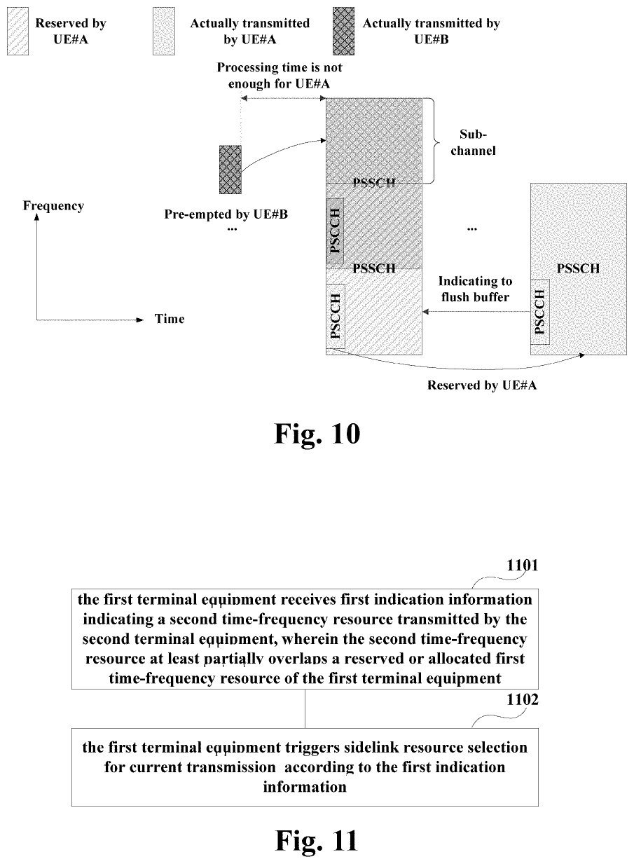

FIG. 10 is still another exemplary diagram of reserving sidelink resource of the embodiment of this disclosure. As shown in FIG. 10, after the resources reserved or allocated for UE #A are pre-empted by UE #B, UE #A determines that time for processing the first indication information is not enough, and buffer flush (third indication information) may be included in SCI transmitted next time, thereby preventing the third terminal equipment from performing erroneous retransmission merging.

In some embodiments, the third indication information indicates whether all buffer data in previous one or more times of transmission are flushed, or indicates whether buffer data in a part of symbols and/or sub-channels in previous one or more times of transmission are flushed.

For example, a particular indication may be of 1 bit, that is, it indicates that all buffered contents transmitted this time need to be flushed; alternatively, additional bit may also be used to indicate buffers of which particular time or times of transmission need to be flushed; alternatively, more bits may also be used to indicate data corresponding to a part of symbols in slots of one time of transmission or a part of sub-channels of one time of transmission need to be flushed.

Therefore, with the third indication information indicating flushing buffered data (buffer flush mechanism), Mode 1 UE or Mode 2 UE may reduce errors of data merging when the sidelink resources are pre-empted. The influence of the sidelink resource pre-emption mechanism on the terminal equipment of the pre-empted resources may be reduced, so that it may normally transmit the sidelink data.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It can be seen from the above embodiments that a mechanism of pre-emption of resources on a sidelink when a terminal equipment operates in Mode 1 or Mode 2 is supported, which may not only satisfy requirements of high-priority services on latency and reliability, but also taking into account influences on various situations.

### Embodiments of a Fourth Aspect

The embodiments of this disclosure are described on the basis of the embodiments of the first to the third aspects. The embodiments may be executed separately, or may be executed in combination with the embodiments of the first to the third aspects, with contents identical to those in the embodiments of the first to the third aspects being not going to be described herein any further.

The embodiments are described from a first terminal equipment. Wherein, the first terminal equipment is taken as a transmitter of service data to transmit sidelink data to one or more third terminal equipments, and a second terminal equipment is taken as a transmitter of another service data, with priorities of transmitting service data being higher than priorities of transmitting service data by the first terminal equipment.

FIG. 11 is still another schematic diagram of the method for reserving sidelink resources of the embodiment of this disclosure. As shown in FIG. 11, the method includes:

1101: the first terminal equipment receives first indication information indicating a second time-frequency resource transmitted by the second terminal equipment, wherein the second time-frequency resource at least partially overlaps a reserved or allocated first time-frequency resource of the first terminal equipment; and

1102: the first terminal equipment triggers sidelink resource selection for current transmission according to the first indication information.

It should be noted that FIG. 11 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 11.

In this disclosure, the first time-frequency resource of the first terminal equipment is allocated by the network device, that is, the first terminal equipment operates in Mode 1. A priority indicated by the first indication information is higher than a priority indicated by the sidelink control information corresponding to the first time-frequency resource. After the allocated first time-frequency resource is pre-empted, the first terminal equipment as the Mode 1 UE triggers one time of resource selection process of the Mode 2 UE.

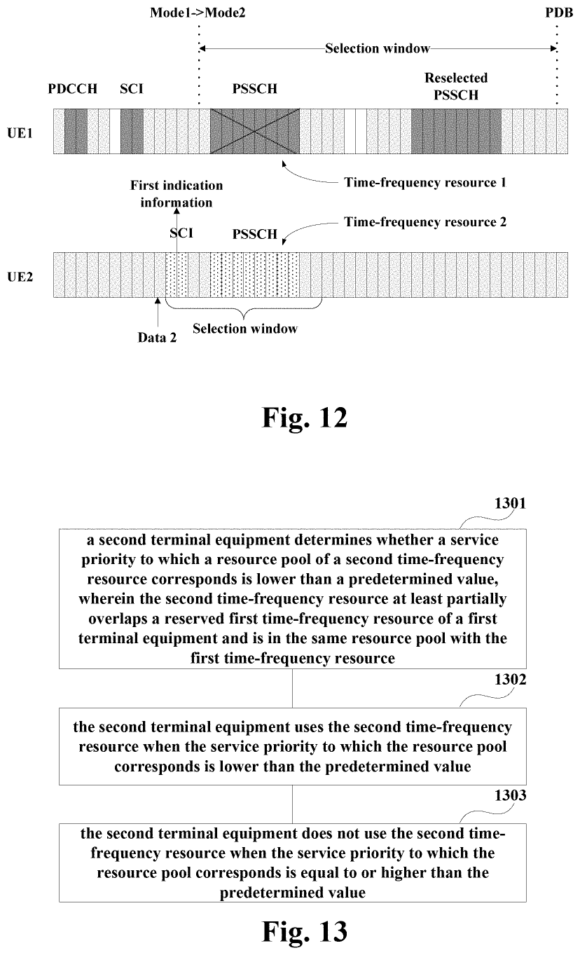

FIG. 12 is an exemplary diagram of reserving sidelink resource of the embodiment of this disclosure. As shown in FIG. 12, UE 1 is a Mode 1 UE, and is allocated with multiple sidelink resources (pre-allocated by the network device), including a time-frequency resource 1 (e.g. a value of PPPP is 6). UE 2 is a Mode 2 UE, and after service data (data 2, for example, a value of PPPP is 2) arrive, UE 2 performs resource selection in a selection window to obtain multiple sidelink resources for transmitting data 2, including time-frequency resource 2. UE 2 will transmit SCI indicating resource reservation information (first indication information), the SCI indicating time-frequency resource 2 and the PPPP value 2.

After UE 1 receives the SCI, it determines that time-frequency resource 1 and time-frequency resource 2 at least partially overlap and the priority of the PPPP value 2 is higher than the priority of PPPP value 6, then UE 1 deems that time-frequency resource 1 will be pre-empted by UE 2. UE 1 may switch from Mode 1 to Mode 2 and trigger one time of resource selection process of Mode 2 UE; and as shown in FIG. 12, UE 1 will perform sidelink resource selection in the selection window to obtain reselected PSSCH resource.

In some embodiments, the resource selection window of the sidelink resource selection starts from a moment when the first indication information is successfully demodulated or from a first symbol after a next slot or a predetermined number of slots, and ends at a last symbol contained in a resource pool distance from a starting symbol by a predetermined length or a packet delay budget (PDB) length.

The predetermined length is the number of preconfigured or configured (such as being configured by an RRC layer) slots in the resource pool, and the PDB length is the number of symbols of packet delay budget (PDB) of a service to be transmitted. However, this disclosure is not limited thereto; for example, multiple time lengths may be obtained according to the above factors, and then a minimum value is used, etc. And furthermore, the PDB may be determined by a priority of the service to be transmitted.

In some embodiments, an ending position of the resource selection window may be determined according to at least one piece of the following information: a starting position of a first symbol of a feedback resource of a physical uplink control channel (PUCCH), a starting position of a first symbol of a retransmission resource, or a starting position of a first symbol of a reserved resource to be transmitted next time. And furthermore, a minimum value in the PDB may be taken into account. Due to whether it is configured that the PUCCH feeds back to the network device, whether retransmission is configured and whether a next time of transmission periodic services is reserved, the above position may be one or more, and one of them may be determined as actually demanded.

It should be noted that the resource selection window is illustrated above only, and this disclosure is not limited thereto.

In some embodiments, after this time of transmission, the first terminal equipment that has triggered one shot of Mode 2 may continue to be recovered to Mode 1, and subsequent transmission resources are still allocated by the network device.

Therefore, even if the currently transmitted sidelink resources are pre-empted, sufficient resources may still be obtained for the current transmission through resource selection. The influence of the sidelink resource pre-emption mechanism on the terminal equipment of the pre-empted resources may be reduced, so that it may normally perform sidelink data transmission.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It can be seen from the above embodiments that a mechanism of pre-emption of resources on a sidelink when a terminal equipment operates in Mode 1 or Mode 2 is supported, which may not only satisfy requirements of high-priority services on latency and reliability, but also taking into account influences on various situations.

### Embodiments of a Fifth Aspect

The embodiments of this disclosure are described on the basis of the embodiments of the first to the fourth aspects. The embodiments may be executed separately, or may be executed in combination with the embodiments of the first to the fourth aspects, with contents identical to those in the embodiments of the first to the fourth aspects being not going to be described herein any further.

The embodiments are described from a second terminal equipment. A first terminal equipment is taken as a transmitter of service data to transmit sidelink data to one or more third terminal equipments, and the second terminal equipment is taken as a transmitter of another service data, with priorities of transmitting service data being higher than priorities of transmitting service data by the first terminal equipment.

In the disclosure, the first time-frequency resource of the first terminal equipment may be obtained by selecting sidelink resources, that is, the first terminal equipment operates in Mode 2. The second time-frequency resource of the second terminal equipment may be obtained through allocation by a network device, that is, the second terminal equipment operates in Mode 1.

FIG. 13 is a schematic diagram of a method for reserving sidelink resources according to an embodiment of this disclosure. As shown in FIG. 13, the method includes:

1301: a second terminal equipment determines whether a service priority to which a resource pool of a second time-frequency resource corresponds is lower than a predetermined value, wherein the second time-frequency resource is allocated by a network device, at least partially overlaps a reserved first time-frequency resource of a first terminal equipment and is in the same resource pool with the first time-frequency resource; and

1302: the second terminal equipment uses the second time-frequency resource when the service priority to which the resource pool corresponds is lower than the predetermined value.

In some embodiments, as shown in FIG. 13, the method further includes:

1303: the second terminal equipment does not use the second time-frequency resource when the service priority to which the resource pool corresponds is equal to or higher than the predetermined value.

It should be noted that FIG. 13 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 13.

In some embodiments, the first time-frequency resource of the first terminal equipment is obtained by selecting sidelink resources, that is, the first terminal equipment operates in Mode 2. The first terminal equipment may be configured with multiple resource pools and one of the resource pools is activated according to a service priority.

For example, there exist mapping relationships between a service priority of each time of transmission by Mode 2 UE and different resource pools, that is, Mode 2 UE is configured with multiple resource pools, and one of the resource pools is activated in each time of transmission, and there exists a mapping relationship between the activated resource pool and the service priority.

In some embodiments, by detecting a common physical downlink control channel (such as a group common PDCCH) transmitted by the network device or by receiving the first indication information transmitted by the second terminal equipment, the first terminal equipment is indicated that its reserved or allocated first time-frequency resource is at least partially occupied.

Therefore, only in a resource pool to which a service with a lower priority (below certain configuration or a preconfigured threshold) corresponds, sidelink resource pre-emption is supported. The influence of the sidelink resource pre-emption mechanism on the terminal equipment of the pre-empted resources may be reduced, so that it may normally perform sidelink data transmission.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It can be seen from the above embodiments that a mechanism of pre-emption of resources on a sidelink when a terminal equipment operates in Mode 1 or Mode 2 is supported, which may not only satisfy requirements of high-priority services on latency and reliability, but also taking into account influences on various situations.

### Embodiments of a Sixth Aspect

The embodiments of this disclosure provide an apparatus for reserving sidelink resources. The apparatus may be, for example, a terminal equipment (such as the first terminal equipment or the second terminal equipment described above), or may be one or more components or assemblies configured in a terminal equipment. Contents in the embodiments identical to those in the embodiments of the first to the fifth aspects shall not be described herein any further.

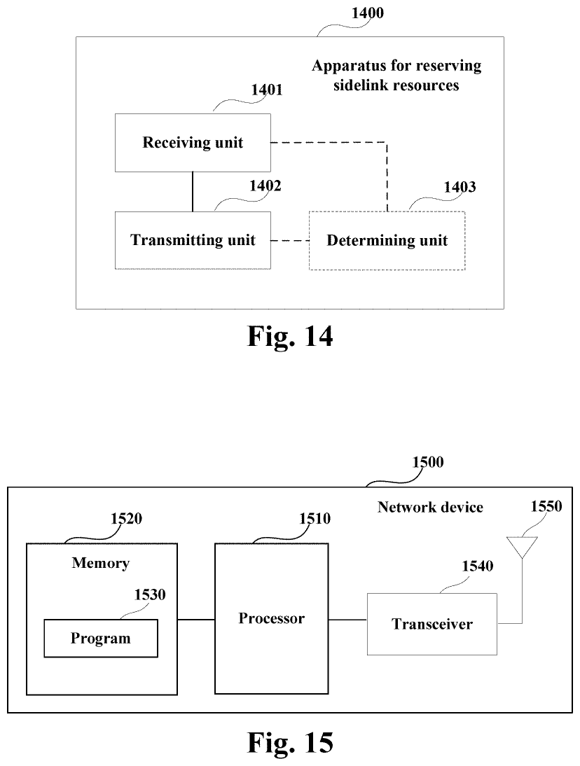

FIG. 14 is a schematic diagram of the apparatus for reserving sidelink resources of the embodiment of this disclosure.

In some embodiments, as shown in FIG. 14, the apparatus 1400 for reserving sidelink resources includes:

a receiving unit 1401 configured to receive first indication information indicating a second time-frequency resource transmitted by a second terminal equipment, wherein the second time-frequency resource at least partially overlaps a reserved or allocated first time-frequency resource of the first terminal equipment; and

a transmitting unit 1402 configured to transmit to a network device second indication information indicating that the first time-frequency resource is at least partially pre-empted.

In some embodiments, the first time-frequency resource is allocated by the network device, and a priority indicated by the first indication information is higher than a priority indicated by sidelink control information to which the first time-frequency resource corresponds; and the second indication information is further used to request the network device for further allocating additional sidelink resources for the first terminal equipment.

In some embodiments, the second indication information is carried in a scheduling request or a buffer status report transmitted by the first terminal equipment to the network device.

In some embodiments, in a case where there exists no uplink resource in a period of time, the scheduling request including or indicating or carrying the second indication information is transmitted on a physical uplink control channel used for sidelink scheduling request after demodulation of the first indication information is completed.

In some embodiments, in a case where there exists an uplink resource in a period of time, the buffer status report including or indicating or carrying the second indication information is transmitted on the uplink resource after demodulation of the first indication information is completed.

In some embodiments, the second indication information is transmitted under at least one of the following conditions that:

blind repeated transmission of a transport block is not configured in sidelink resource pool configuration information, feedback-based repeated transmission is not configured in sidelink resource pool configuration information, the terminal equipment being able to report feedback information to the network device is not configured in a sidelink resource pool, an uplink resource reporting feedback information to the network device is not configured in a sidelink resource pool, or sidelink resource pool configuration information contains indication of resource pre-emption enabling.

In some embodiments, the second indication information is carried in a feedback message transmitted by the first terminal equipment to the network device.

In some embodiments, the feedback message including or indicating or carrying the second indication information is transmitted when hybrid automatic repeat request feedback is enabled and an uplink resource reporting feedback information to the network device is configured.

In some embodiments, the second indication information is NACK, or indication information different from ACK or NACK.

In some embodiments, the first time-frequency resource is used for first groupcast data of sidelink, and the second indication information is NACK.

In some embodiments, the second indication information is transmitted when remaining resources other than the pre-empted time-frequency resources are unable to satisfy a transmission demand of the first terminal equipment for a current transport block.

In some embodiments, the receiving unit 1401 receives first indication information indicating the second time-frequency resource transmitted by the second terminal equipment, the second time-frequency resource at least partially overlapping with the first time-frequency resource reserved or allocated by the first terminal equipment; and the transmitting unit 1402 uses remaining resources in the first time-frequency resource that do not overlap with the second time-frequency resource to transmit the sidelink control information and/or the sidelink data to the third terminal equipment.

In some embodiments, the first time-frequency resource is allocated by the network device or obtained by selecting sidelink resources; and the priority indicated by the first indication information is higher than the priority indicated by the sidelink control information to which the first time-frequency resource corresponds.

In some embodiments, the remaining resources include one or more sub-channels, and the transmitting unit 1402 uses one sub-channel (single sub-channel) of the remaining resources to transmit the sidelink control information and/or the sidelink data to the third terminal equipment.

In some embodiments, the sub-channel at least includes physical sidelink control channel resources. A frequency-domain index of the sub-channel in the remaining resources is lowest, or a frequency-domain index of the sub-channel in the remaining resources is highest, or the sub-channel is a configured or pre-configured resource in the remaining resources.

In some embodiments, in a case where the current transmission is one time of transmission of multiple times of transmission, one sub-channel (single sub-channel) selected from the remaining resources is used to transmit the sidelink control information used for indicating a next time of transmission resources or multiple transmission resources; wherein the current transmission is one time of transmission in which multiple times of retransmission based on feedback or multiple times of blind retransmission are configured for the same TB and is not the last time of transmission, and/or, the current transmission is one time of transmission in a periodic service and no resource reselection is triggered

In some embodiments, the sidelink control information transmitted at the last time in the multiple times of transmission further includes reservation information of one or more times of transmission; wherein the sidelink resource selection is performed based on the resource selection window to obtain the resources of one or more times of transmission.

In some embodiments, the receiving unit 1402 receives first indication information indicating a second time-frequency resource transmitted by the second terminal equipment, the second time-frequency resource at least partially overlapping with the first time-frequency resource reserved or allocated by the first terminal equipment.

As shown in FIG. 14, the apparatus 1400 for reserving sidelink resources further includes: a determining unit 1403 configured to determine whether a period of time between a first time at which a first terminal equipment completes in reception of first indication information and a second time at which first time-frequency resource is used by the first terminal equipment to transmit sidelink data is less than a threshold.

The transmitting unit 1402 transmits third indication information instructing to flush buffered data to the third terminal equipment receiving the sidelink data when the time period is less than the threshold.

In some embodiments, the first time-frequency resource is allocated by the network device or obtained by selecting sidelink resources; and a priority indicated by the first indication information is higher than that indicated by the sidelink control information to which the first time-frequency resource corresponds.

In some embodiments, in a case where the current transmission is one time of transmission of multiple times of transmission, the third indication information is carried in sidelink control information of a time of transmission after the current transmission, and indicates whether buffer data transmitted in one or more previous times are flushed.

In some embodiments, the third indication information indicates whether all buffer data in previous one or more times of transmission are flushed, or indicates whether buffer data in a part of symbols and/or sub-channels in previous one or more times of transmission are flushed.

In some embodiments, the determining unit 1403 determines whether the period of time between the first time at which the first terminal equipment completes in reception of first indication information and the second time at which the first time-frequency resource is used by the first terminal equipment to transmit sidelink data is less than a threshold; wherein the reserved or allocated first time-frequency resource of the first terminal equipment at least partially overlaps with the second time-frequency resource to be used by the second terminal equipment; and the second time-frequency resource is not used when the time period is less than the threshold.

In some embodiments, the receiving unit 1401 receives the first indication information indicating the second time-frequency resource transmitted by the second terminal equipment, the second time-frequency resource at least partially overlapping with the reserved or allocated first time-frequency resource of the first terminal equipment; and the determining unit 1403 triggers sidelink resource selection for the current transmission according to the first indication information.

In some embodiments, the first time-frequency resource is allocated by the network device; and a priority indicated by the first indication information is higher than a priority indicated by the sidelink control information to which the first time-frequency resource corresponds.

In some embodiments, the resource selection window of the sidelink resource selection starts from a moment when the first indication information is successfully demodulated or from a first symbol after a next slot, and ends at a last symbol contained in a resource pool distance from a starting symbol by a predetermined length or a packet delay budget (PDB) length.

In some embodiments, the predetermined length is the number of preconfigured or configured slots in the resource pool, and the PDB length is the number of symbols of packet delay budget (PDB) of a service to be transmitted.

In some embodiments, an ending position of the resource selection window may be determined according to at least one piece of the following information: a starting position of a first symbol of a feedback resource of a physical uplink control channel (PUCCH), a starting position of a first symbol of a retransmission resource, or a starting position of a first symbol of a reserved resource to be transmitted next time.

In some embodiments, the determining unit 1403 determines whether a service priority to which the resource pool of the second time-frequency resource corresponds is lower than a preset value; wherein the second time-frequency resource is allocated by the network device, and at least partially overlaps with the reserved first time-frequency resource of the first terminal equipment and is in the same resource pool with the first time-frequency resource; and when the service priority to which the resource pool corresponds is lower than the preset value, the second time-frequency resource is used.

In some embodiments, the first time-frequency resource is obtained by selecting sidelink resources; and the first terminal equipment is configured with multiple resource pools and one of the resource pools is activated according to a service priority.

In some embodiments, when the service priority to which the resource pool corresponds is equal to or higher than the preset value, the second time-frequency resource is not used.

In some embodiments, by detecting a common physical downlink control channel transmitted by the network device or by receiving the first indication information transmitted by the second terminal equipment, the first terminal equipment is indicated that the first time-frequency resource is at least partially occupied.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the apparatus 1400 for reserving sidelink resources may further include other components or modules, and reference may be made to related techniques for particulars of these components or modules.

Furthermore, for the sake of simplicity, connection relationships between the components or modules or signal profiles thereof are only illustrated in FIG. 14. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

It can be seen from the above embodiments that a mechanism of pre-emption of resources on a sidelink when a terminal equipment operates in Mode 1 or Mode 2 is supported, which may not only satisfy requirements of high-priority services on latency and reliability, but also taking into account influences on various situations.

### Embodiments of a Seventh Aspect

The embodiments of this disclosure provide a communication system, and reference may be made to FIG. 1, with contents identical to those in the embodiments of the first to the sixth aspects being not going to be described herein any further.

In some embodiments, the communication system 100 may at least include:

a first terminal equipment configured to receive first indication information indicating a second time-frequency resource, the second time-frequency resource at least partially overlapping with a reserved or allocated first time-frequency resource of the first terminal equipment, and transmit second indication information indicating that the first time-frequency resource is at least partially pre-empted;

a second terminal equipment configured to transmit the first indication information; and

a network device configured to receive the second indication information.

In some embodiments, the communication system 100 may at least include:

a first terminal equipment configured to receive first indication information indicating a second time-frequency resource, the second time-frequency resource at least partially overlapping with a reserved or allocated first time-frequency resource of the first terminal equipment, and transmit sidelink control information and/or sidelink data by using remaining resources in the first time-frequency resource not overlapping with the second time-frequency resource;

a second terminal equipment configured to transmit the first indication information; and

a third terminal equipment configured to receive the sidelink control information and/or sidelink data.

In some embodiments, the communication system 100 may at least include:

a first terminal equipment configured to receive first indication information indicating a second time-frequency resource, the second time-frequency resource at least partially overlapping with a reserved or allocated first time-frequency resource of the first terminal equipment, determine whether a period of time between a first time at which reception of the first indication information is completed and a second time at which the first time-frequency resource is used by the first terminal equipment to transmit sidelink data is less than a threshold, and when the period of time is less than the threshold, transmit third indication information indicating flushing buffer data to a third terminal equipment;

a second terminal equipment configured to transmit the first indication information; and

a third terminal equipment configured to receive the sidelink data and receive the third indication information.

In some embodiments, the communication system 100 may at least include:

a first terminal equipment configured to receive first indication information indicating a second time-frequency resource, the second time-frequency resource at least partially overlapping with a reserved or allocated first time-frequency resource of the first terminal equipment, and trigger sidelink resource selection for current transmission according to the first indication information; and

a second terminal equipment configured to transmit the first indication information.

In some embodiments, the communication system 100 may at least include:

a first terminal equipment configured to be reserved or allocated with a first time-frequency resource, wherein the first time-frequency resource and a second time-frequency resource to be used by a second terminal equipment at least partially overlap and are in the same resource pool; and

the second terminal equipment configured to determine whether a service priority to which a resource pool of the second time-frequency resource corresponds is lower than a preset value, and use the second time-frequency resource when the service priority to which the resource pool of the second time-frequency resource corresponds is lower than the preset value.

The embodiment of this disclosure further provides a network device, which may be, for example, a base station. However, this disclosure is not limited thereto, and it may also be another network device.

FIG. 15 is a schematic diagram of a structure of the network device of the embodiment of this disclosure. As shown in FIG. 15, the network device 1500 may include a processor 1510 (such as a central processing unit (CPU)) and a memory 1520, the memory 1520 being coupled to the processor 1510. The memory 1520 may store various data, and furthermore, it may store a program 1530 for information processing, and execute the program 1530 under control of the processor 1510.

Furthermore, as shown in FIG. 15, the network device 1500 may include a transceiver 1540, and an antenna 1550, etc. Functions of the above components are similar to those in the prior art, and shall not be described herein any further. It should be noted that the network device 1500 does not necessarily include all the parts shown in FIG. 15, and furthermore, the network device 1500 may include parts not shown in FIG. 15, and the relevant art may be referred to.

The embodiment of this disclosure further provides a terminal equipment; however, this disclosure is not limited thereto, and it may also be another equipment.

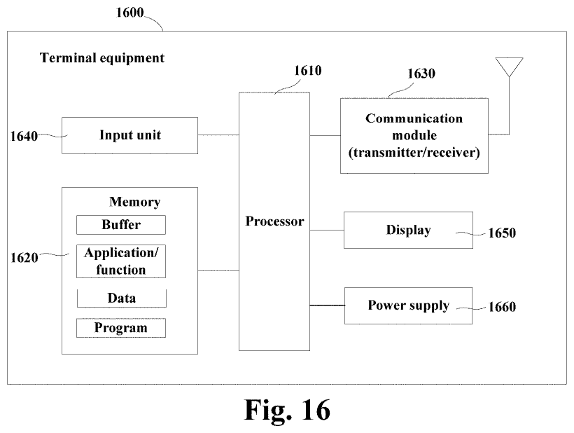

FIG. 16 is a schematic diagram of the terminal equipment of the embodiment of this disclosure. As shown in FIG. 16, the terminal equipment 1600 may include a processor 1610 and a memory 1620, the memory 1620 storing data and a program and being coupled to the processor 1610. It should be noted that this figure is illustrative only, and other types of structures may also be used, so as to supplement or replace this structure and achieve a telecommunications function or other functions.

For example, the processor 1610 may be configured to execute a program to carry out the method for reserving sidelink resources as described in the embodiment of the first aspect. For example, the processor 1610 may be configured to perform the following control: receiving first indication information indicating a second time-frequency resource transmitted by a second terminal equipment, the second time-frequency resource at least partially overlapping with a reserved or allocated first time-frequency resource of the first terminal equipment; and transmitting second indication information indicating that the first time-frequency resource is at least partially pre-empted to a network device.

For example, the processor 1610 may be configured to execute a program to carry out the method for reserving sidelink resources as described in the embodiment of the second aspect. For example, the processor 1610 may be configured to perform the following control: receiving first indication information indicating a second time-frequency resource transmitted by a second terminal equipment, the second time-frequency resource at least partially overlapping with a reserved or allocated first time-frequency resource of the first terminal equipment, and transmitting sidelink control information and/or sidelink data to a third terminal equipment by using remaining resources in the first time-frequency resource not overlapping with the second time-frequency resource.

For example, the processor 1610 may be configured to execute a program to carry out the method for reserving sidelink resources as described in the embodiment of the third aspect. For example, the processor 1610 may be configured to perform the following control: determining whether a period of time between a first time at which a first terminal equipment completes in reception of first indication information indicating a second time-frequency resource and a second time at which first time-frequency resource is used by the first terminal equipment to transmit sidelink data is less than a threshold, wherein the reserved or allocated first time-frequency resource of the first terminal equipment at least partially overlaps the second time-frequency resource to be used by the second terminal equipment; and not using the second time-frequency resource when the period of time is less than the threshold;

or, receiving first indication information indicating a second time-frequency resource transmitted by a second terminal equipment, the second time-frequency resource at least partially overlapping with a reserved or allocated first time-frequency resource of the first terminal equipment; determining whether a period of time between a first time at which reception of the first indication information is completed and a second time at which the first time-frequency resource is used by the first terminal equipment to transmit sidelink data is less than a threshold; and when the period of time is less than the threshold, transmitting third indication information indicating flushing buffer data to a third terminal equipment receiving the sidelink data.

For example, the processor 1610 may be configured to execute a program to carry out the method for reserving sidelink resources as described in the embodiment of the fourth aspect. For example, the processor 1610 may be configured to perform the following control: receiving first indication information indicating a second time-frequency resource transmitted by the second terminal equipment, the second time-frequency resource at least partially overlapping with a reserved or allocated first time-frequency resource of the first terminal equipment; and triggering sidelink resource selection for current transmission according to the first indication information.

For example, the processor 1610 may be configured to execute a program to carry out the method for reserving sidelink resources as described in the embodiment of the fifth aspect. For example, the processor 1610 may be configured to perform the following control: determining whether a service priority to which a resource pool of a second time-frequency resource corresponds is lower than a predetermined value, wherein the second time-frequency resource at least partially overlaps a reserved first time-frequency resource of a first terminal equipment and is in the same resource pool with the first time-frequency resource; and using the second time-frequency resource when the service priority to which the resource pool corresponds is lower than the predetermined value.

As shown in FIG. 16, the terminal equipment 1600 may further include a communication module 1630, an input unit 1640, a display 1650, and a power supply 1660; wherein functions of the above components are similar to those in the relevant art, which shall not be described herein any further. It should be noted that the terminal equipment 1600 does not necessarily include all the parts shown in FIG. 16, and the above components are not necessary. Furthermore, the terminal equipment 1600 may include parts not shown in FIG. 16, and the relevant art may be referred to.

An embodiment of this disclosure provides a computer program, which, when executed in a terminal equipment, will cause the terminal equipment to carry out the method for reserving sidelink resources as described in the embodiments of the first to the fifth aspects.

An embodiment of this disclosure provides a storage medium, including a computer program, which will cause a terminal equipment to carry out the method for reserving sidelink resources as described in the embodiments of the first to the fifth aspects.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present invention. Various variants and modifications may be made by those skilled in the art according to the spirits and principle of the present invention, and such variants and modifications fall within the scope of the present invention.

As to implementations containing the above embodiments, following supplements are further disclosed.

Supplement 1. A method for reserving sidelink resources, including:

receiving, by a first terminal equipment, first indication information indicating a second time-frequency resource transmitted by a second terminal equipment, wherein the second time-frequency resource at least partially overlaps a reserved or allocated first time-frequency resource of the first terminal equipment; and

transmitting, by the first terminal equipment to a network device, second indication information indicating that the first time-frequency resource is at least partially pre-empted.

Supplement 2. The method according to supplement 1, wherein the first time-frequency resource of the first terminal equipment is allocated by the network device, and a priority indicated by the first indication information is higher than a priority indicated by sidelink control information to which the first time-frequency resource corresponds.

Supplement 3. The method according to supplement 1 or 2, wherein the second indication information is further used to request the network device for further allocating additional sidelink resources for the first terminal equipment.

Supplement 4. The method according to any one of supplements 1-3, wherein the second indication information is carried in a scheduling request (SR) or a buffer status report (BSR) transmitted by the first terminal equipment to the network device.

Supplement 5. The method according to supplement 4, wherein the buffer status report is triggered according to the first indication information, and/or the scheduling request is transmitted when there is no uplink resource.

Supplement 6. The method according to supplement 4, wherein when the first terminal equipment has no uplink resources for a period of time, on a physical uplink control channel used for the sidelink scheduling request after completing demodulation of the first indication information, the scheduling request including or indicating or carrying the second indication information is transmitted.

Supplement 7. The method according to supplement 4, wherein when the first terminal equipment has uplink resources for a period of time, on an uplink resource after completing demodulation of the first indication information, the buffer status report including or indicating or carrying the second indication information is transmitted.

Supplement 8. The method according to any one of supplements 4-7, wherein under at least one of the following conditions, the first terminal equipment transmits the second indication information to the network device:

blind repeated transmission of a transport block is not configured in sidelink resource pool configuration information, feedback-based repeated transmission is not configured in sidelink resource pool configuration information, the terminal equipment being able to report feedback information to the network device is not configured in a sidelink resource pool, an uplink resource reporting feedback information to the network device is not configured in a sidelink resource pool, or sidelink resource pool configuration information contains indication of resource pre-emption enabling.

Supplement 9. The method according to any one of supplements 1-3, wherein the second indication information is carried in a feedback message transmitted by the first terminal equipment to the network device.

Supplement 10. The method according to supplement 9, wherein when hybrid automatic repeat request (HARQ) feedback is enabled and an uplink resource reporting feedback information to the network device is configured, the first terminal equipment transmits the feedback message including or indicating or carrying the second indication information.

Supplement 11. The method according to supplement 9 or 10, wherein the second indication information is NACK, or is indication information different from ACK or NACK.

Supplement 12. The method according to supplement 9 or 10, wherein the first time-frequency resource is used for first groupcast data of a sidelink, and the second indication information transmitted by the first terminal equipment to the network device is NACK.

Supplement 13. The method according to supplement 12, wherein the first groupcast data is transmitted by the first terminal equipment to at least two third terminal equipments, the at least two third terminal equipments being able to feed back NACK in the same physical sidelink feedback channel in case of wrong decoding.

Supplement 14. The method according to any one of supplements 9-13, wherein under at least one of the following conditions, the first terminal equipment transmits the second indication information:

blind repeated transmission of a transport block is not configured in sidelink resource pool configuration information, feedback-based repeated transmission is not configured in sidelink resource pool configuration information, or sidelink resource pool configuration information contains indication of resource pre-emption enabling.

Supplement 15. The method according to any one of supplements 1-14, wherein when remaining resources other than the pre-empted time-frequency resources are unable to satisfy a transmission demand of the first terminal equipment for a current transport block, the first terminal equipment transmits the second indication information.

Supplement 16. A method for reserving sidelink resources, including:

receiving, by a first terminal equipment, first indication information indicating a second time-frequency resource transmitted by a second terminal equipment, wherein the second time-frequency resource at least partially overlaps a reserved or allocated first time-frequency resource of the first terminal equipment; and

transmitting sidelink control information and/or sidelink data by the first terminal equipment to a third terminal equipment by using remaining resources in the first time-frequency resource not overlapping with the second time-frequency resource.

Supplement 17. The method according to supplement 16, wherein the first time-frequency resource of the first terminal equipment is allocated by a network device or is obtained by sidelink resource selection, and a priority indicated by the first indication information is higher than a priority indicated by sidelink control information to which the first time-frequency resource corresponds.

Supplement 18. The method according to supplement 16 or 17, wherein the remaining resources include one or more sub-channels, and the first terminal equipment uses one sub-channel in the remaining resources to transmit the sidelink control information and/or sidelink data to the third terminal equipment.

Supplement 19. The method according to any one of supplements 16-18, wherein in a case where current transmission is one of multiple times of transmission, the first terminal equipment uses the remaining resources to transmit the sidelink control information used for indicating a next time of transmission resources or multiple transmission resources.

Supplement 20. The method according to supplement 19, wherein the current transmission is transmission in which multiple times of feedback-based retransmission or blind retransmission are configured for the same transport block and is not the last transmission, and/or the current transmission is transmission in a periodic service and does not trigger resource reselection.

Supplement 21. The method according to supplement 18, wherein the sub-channel at least includes a physical sidelink control channel resource;

and a frequency-domain index of the sub-channel in the remaining resources is lowest, or a frequency-domain index of the sub-channel in the remaining resources is highest, or the sub-channel is a configured or preconfigured resource in the remaining resources.

Supplement 22. The method according to any one of supplements 19-21, wherein the sidelink control information of the last time of transmission in the multiple times of transmission further includes reservation information of one or more times of transmission.

Supplement 23. The method according to supplement 22, wherein resources of the one or more times of transmission are obtained by performing sidelink resource selection based on a resource selection window.

Supplement 24. A method for reserving sidelink resources, including:

determining, by a second terminal equipment, whether a period of time between a first time at which a first terminal equipment completes in reception of first indication information indicating a second time-frequency resource and a second time at which first time-frequency resource is used by the first terminal equipment to transmit sidelink data is less than a threshold, wherein the reserved or allocated first time-frequency resource of the first terminal equipment at least partially overlaps the second time-frequency resource to be used by the second terminal equipment; and

not using the second time-frequency resource, by the second terminal equipment, when the period of time is less than the threshold.

Supplement 25. The method according to supplement 24, wherein the first time-frequency resource of the first terminal equipment is allocated by the network device or is obtained by sidelink resource selection, and a priority indicated by the first indication information is higher than a priority indicated by sidelink control information to which the first time-frequency resource corresponds.

Supplement 26. The method according to supplement 24 or 25, wherein the threshold is predefined or preconfigured or configured, and/or the threshold is determined according to a processing time of another terminal equipment capable of successfully processing the first indication information.

Supplement 27. A method for reserving sidelink resources, including:

receiving, by a first terminal equipment, first indication information indicating a second time-frequency resource transmitted by a second terminal equipment, wherein the second time-frequency resource at least partially overlaps a reserved or allocated first time-frequency resource of the first terminal equipment;

determining, by the first terminal equipment, whether a period of time between a first time at which reception of the first indication information is completed and a second time at which the first time-frequency resource is used by the first terminal equipment to transmit sidelink data is less than a threshold; and

when the period of time is less than the threshold, transmitting third indication information indicating clearing buffer data by the first terminal equipment to a third terminal equipment receiving the sidelink data.

Supplement 28. The method according to supplement 27, wherein the first time-frequency resource of the first terminal equipment is allocated by the network device, and a priority indicated by the first indication information is higher than a priority indicated by sidelink control information to which the first time-frequency resource corresponds.

Supplement 29. The method according to supplement 27 or 28, wherein the threshold is predefined or preconfigured or configured, and/or the threshold is determined according to a processing time of another terminal equipment capable of successfully processing the first indication information.

Supplement 30. The method according to any one of supplements 27-29, wherein in a case where current transmission is one of multiple times of transmission, the third indication information is carried in sidelink control information of a time of transmission after the current transmission, and indicates whether buffer data transmitted in one or more preceding times of transmission are flushed.

Supplement 31. The method according to any one of supplements 27-30, wherein the third indication information indicates whether all buffer data transmitted in one or more preceding times of transmission are flushed, or indicates whether buffer data of a part of symbols and/or sub-channels transmitted in one or more preceding times of transmission are flushed.

Supplement 32. A method for reserving sidelink resources, including:

receiving, by a first terminal equipment, first indication information indicating a second time-frequency resource transmitted by a second terminal equipment, wherein the second time-frequency resource at least partially overlaps a reserved or allocated first time-frequency resource of the first terminal equipment; and

triggering sidelink resource selection for current transmission by the first terminal equipment according to the first indication information.

Supplement 33. The method according to supplement 32, wherein the first time-frequency resource is allocated by the network device, and a priority indicated by the first indication information is higher than a priority indicated by sidelink control information to which the first time-frequency resource corresponds.

Supplement 34. The method according to supplement 32 or 33, wherein a resource selection window of the sidelink resource selection starts from a moment when the first indication information is successfully demodulated or from a first symbol after a next slot or a predetermined number of slots, and ends at a last symbol contained in a resource pool distance from a starting symbol by a predetermined length or a packet delay budget (PDB) length.

Supplement 35. The method according to supplement 34, wherein the predetermined length is the number of preconfigured or configured slots in the resource pool, and the packet delay budget (PDB) length is the number of symbols of packet delay budget (PDB) of a service to be transmitted.

Supplement 36. The method according to supplement 34 or 35, wherein an ending position of the resource selection window is determined according to at least one piece of the following information: a starting position of a first symbol of a feedback resource of a physical uplink control channel (PUCCH), a starting position of a first symbol of a retransmission resource, or a starting position of a first symbol of a reserved resource to be transmitted next time.

Supplement 37. A method for reserving sidelink resources, including:

determining, by a second terminal equipment, whether a service priority to which a resource pool of a second time-frequency resource corresponds is lower than a predetermined value, wherein the second time-frequency resource is allocated by a network device, at least partially overlaps a reserved first time-frequency resource of a first terminal equipment and is in the same resource pool with the first time-frequency resource; and

using the second time-frequency resource by the second terminal equipment when the service priority to which the resource pool corresponds is lower than the predetermined value.

Supplement 38. The method according to supplement 37, wherein the first time-frequency resource of the first terminal equipment is obtained by sidelink resource selection, the first terminal equipment is configured with multiple resource pools and one of the resource pools is activated according to the service priority.

Supplement 39. The method according to supplement 37 or 38, wherein the method further includes:

not using the second time-frequency resource by the second terminal equipment when the service priority to which the resource pool corresponds is equal to or higher than the predetermined value.

Supplement 40. The method according to supplements 37-39, wherein by detecting a common physical downlink control channel transmitted by a network device or by receiving first indication information transmitted by the second terminal equipment, the first terminal equipment is indicated that the first time-frequency resource is at least partially pre-empted.

Supplement 41. A terminal equipment, including a memory and a processor, the memory storing a computer program, and the processor being configured to execute the computer program to carry out the method for reserving sidelink resources as described in any one of supplements 1-40.

Supplement 42. A communication system, including:

a first terminal equipment configured to receive first indication information indicating a second time-frequency resource, the second time-frequency resource at least partially overlapping with a reserved or allocated first time-frequency resource of the first terminal equipment, and transmit indication information indicating that the first time-frequency resource is at least partially pre-empted;

a second terminal equipment configured to transmit the first indication information; and

a network device configured to receive the second indication information.

Supplement 43. A communication system, including:

a first terminal equipment configured to receive first indication information indicating a second time-frequency resource, the second time-frequency resource at least partially overlapping with a reserved or allocated first time-frequency resource of the first terminal equipment, and transmit sidelink control information and/or sidelink data by using remaining resources in the first time-frequency resource not overlapping with the second time-frequency resource;

a second terminal equipment configured to transmit the first indication information; and

a third terminal equipment configured to receive the sidelink control information and/or sidelink data.

Supplement 44. A communication system, including:

a first terminal equipment configured to receive first indication information indicating a second time-frequency resource, the second time-frequency resource at least partially overlapping with a reserved or allocated first time-frequency resource of the first terminal equipment, determine whether a period of time between a first time at which reception of the first indication information is completed and a second time at which the first time-frequency resource is used by the first terminal equipment to transmit sidelink data is less than a threshold, and when the period of time is less than the threshold, transmit third indication information indicating flushing buffer data to a third terminal equipment;

a second terminal equipment configured to transmit the first indication information; and

a third terminal equipment configured to receive the sidelink data and receive the third indication information.

Supplement 45. A communication system, including:

a first terminal equipment configured to receive first indication information indicating a second time-frequency resource, the second time-frequency resource at least partially overlapping with a reserved or allocated first time-frequency resource of the first terminal equipment, and trigger sidelink resource selection for current transmission according to the first indication information; and

a second terminal equipment configured to transmit the first indication information.

Supplement 46. A communication system, including:

a first terminal equipment configured to be reserved or allocated with a first time-frequency resource, wherein the first time-frequency resource and a second time-frequency resource to be used by a second terminal equipment at least partially overlap and are in the same resource pool; and

the second terminal equipment configured to determine whether a service priority to which a resource pool of the second time-frequency resource corresponds is lower than a preset value, and use the second time-frequency resource when the service priority to which the resource pool of the second time-frequency resource corresponds is lower than the preset value.

What is claimed is:

1. An apparatus for reserving sidelink resources, configured in a first terminal equipment, the apparatus comprising:
a receiving unit configured to receive first indication information indicating a second time-frequency resource transmitted by a second terminal equipment, wherein the second time-frequency resource at least partially overlaps a reserved or allocated first time-frequency resource of the first terminal equipment; and
a transmitting unit configured to transmit to a network device second indication information indicating that the first time-frequency resource is at least partially pre-empted.

2. The apparatus according to claim 1, wherein the first time-frequency resource is allocated by the network device, and a priority indicated by the first indication information is higher than a priority indicated by sidelink control information to which the first time-frequency resource corresponds;
and the second indication information is further used to request the network device for further allocating additional sidelink resources for the first terminal equipment.

3. The apparatus according to claim 1, wherein the second indication information is carried in a scheduling request or a buffer status report transmitted by the first terminal equipment to the network device;
wherein the buffer status report is triggered according to the first indication information, and/or the scheduling request is transmitted when there exists no uplink resource.

4. The apparatus according to claim 3, wherein in a case where there exists no uplink resource in a period of time, the scheduling request carrying the second indication information is transmitted on a physical uplink control channel used for sidelink scheduling request after demodulation of the first indication information is completed.

5. The apparatus according to claim 3, wherein in a case where there exists an uplink resource in a period of time, the buffer status report carrying the second indication information is transmitted on the uplink resource after demodulation of the first indication information is completed.

6. The apparatus according to claim 1, wherein the second indication information is transmitted under at least one of the following conditions that:
blind repeated transmission of a transport block is not configured in sidelink resource pool configuration information, feedback-based repeated transmission is not configured in sidelink resource pool configuration information, the terminal equipment being able to report feedback information to the network device is not configured in a sidelink resource pool, an uplink resource reporting feedback information to the network device is not configured in a sidelink resource pool, and/or sidelink resource pool configuration information contains indication of resource pre-emption enabling.

7. The apparatus according to claim 1, wherein the second indication information is carried in a feedback message transmitted by the first terminal equipment to the network device.

8. The apparatus according to claim 7, wherein the feedback message carrying the second indication information is transmitted when hybrid automatic repeat request feedback is enabled and an uplink resource reporting feedback information to the network device is configured.

9. The apparatus according to claim 7, wherein the second indication information is NACK, or is indication information different from ACK or NACK.

10. The apparatus according to claim 7, wherein the first time-frequency resource is used for first groupcast data of a sidelink, and the second indication information transmitted by the first terminal equipment to the network device is NACK.

11. The apparatus according to claim 1, wherein the second indication information is transmitted when remaining resources other than the pre-empted time-frequency resources are unable to satisfy a transmission demand of the first terminal equipment for a current transport block.

12. An apparatus for reserving sidelink resources, configured in a first terminal equipment, the apparatus comprising:
a receiving unit configured to receive first indication information indicating a second time-frequency resource transmitted by a second terminal equipment, wherein the second time-frequency resource at least partially overlaps a reserved or allocated first time-frequency resource of the first terminal equipment; and
a transmitting unit configured to transmit sidelink control information and/or sidelink data to a third terminal equipment by using remaining resources in the first time-frequency resource not overlapping with the second time-frequency resource.

13. The apparatus according to claim 12, wherein the first time-frequency resources are allocated by the network device or obtained by sidelink resource selection, and a priority indicated by the first indication information is higher than a priority indicated by sidelink control information to which the first time-frequency resource corresponds.

14. The apparatus according to claim 12, wherein the remaining resources comprise one or more sub-channels,
and the transmitting unit transmits the sidelink control information and/or the sidelink data to the third terminal equipment by using a sub-channel in the remaining resources, the sub-channel at least comprising a physical sidelink control channel resource;
a frequency-domain index of the sub-channel in the remaining resources being lowest, or a frequency-domain index of the sub-channel in the remaining resources being highest, or the sub-channel being a resource configured or preconfigured in the remaining resources.

15. The apparatus according to claim 14, wherein in a case where current transmission is one of multiple times of transmission, the sidelink control information indicating a next time of transmission or multiple transmission resources is transmitted by using the sub-channel selected in the remaining resources;
wherein the current transmission is a time of transmission in which multiple times of feedback-based retransmission or blind retransmission are configured for the same transport block and is not a last time of transmission, and/or the current transmission is a time of transmission in a periodic service and a resource reselection is not triggered.

16. The apparatus according to claim 15, wherein sidelink control information transmitted in a last time of transmission in the multiple times of transmission further comprises reservation information of one or multiple times of transmission;
wherein resources of the one or multiple times of transmission are obtained by sidelink resource selection based on a resource selection window.

17. An apparatus for reserving sidelink resources, configured in a first terminal equipment, the apparatus comprising:
a receiving unit configured to receive first indication information indicating a second time-frequency resource transmitted by a second terminal equipment, wherein the second time-frequency resource at least partially overlaps a reserved or allocated first time-frequency resource of the first terminal equipment;
a determining unit configured to determine whether a period of time between a first time at which reception of the first indication information is completed and a second time at which the first time-frequency resource is used by the first terminal equipment to transmit sidelink data is less than a threshold; and
a transmitting unit configured to, when the period of time is less than the threshold, transmit third indication information indicating flushing buffer data to a third terminal equipment receiving the sidelink data.

18. The apparatus according to claim 17, wherein the first time-frequency resource is allocated by a network device or is obtained by sidelink resource selection, and a priority indicated by the first indication information is higher than a priority indicated by sidelink control information to which the first time-frequency resource corresponds.

19. The apparatus according to claim 17, wherein in a case where current transmission is one of multiple times of transmission, the third indication information is carried in sidelink control information of a time of transmission after the current transmission, and indicates whether buffer data transmitted in one or more preceding times of transmission are flushed.

20. The apparatus according to claim 17, wherein the third indication information indicates whether all buffer data transmitted in one or more preceding times of transmission are flushed, or indicates whether buffer data of a part of symbols and/or sub-channels transmitted in one or more preceding times of transmission are flushed.
